(19) United States
(12) Patent Application Publication
(10) Pub. No.: US 2022/0134502 A1
(43) Pub. Date: May 5, 2022

(54) DUST COLLECTION AND DEBRIS REMOVAL DEVICE

(71) Applicant: Archie Hunnicutt, Naugatuck, CT (US)

(72) Inventor: Archie Hunnicutt, Naugatuck, CT (US)

(21) Appl. No.: 17/517,726

(22) Filed: Nov. 3, 2021

Related U.S. Application Data
(60) Provisional application No. 63/109,593, filed on Nov. 4, 2020.

(51) Int. Cl. B23Q 11/00; A47L 7/00; A47L 9/24

(52) U.S. Cl. CPC B23Q 11/0046; A47L 9/242; A47L 9/248; A47L 7/0095

(57) ABSTRACT

The present invention relates generally to the field of accessories for a stationary tool and more specifically, to a dust collection or debris-removal device that can be connected to the stationary tool. The device includes a frame, a clamp, a hose frame and a vacuum piece to create suction to remove sawdust and other debris from a cutting area. The vacuum piece further has a generally circular or half-circular cutout that allows a user to position the piece around a drill bit while the cutting element while it is in use. The vacuum piece provides an angle of suction around the cutting piece ranging from 300 to 350 degrees to provide adequate suction in order to capture the maximum amount of sawdust and or debris produced by the stationary tool during use.

### CROSS-REFERENCE TO RELATED APPLICATION

The present application claims priority to, and the benefit of, U.S. Provisional Application No. 63/109,593, which was filed on Nov. 4, 2020, and is incorporated herein by reference in its entirety.

### FIELD OF THE INVENTION

The present invention relates generally to the field of accessories for shop tools. More specifically, the present invention relates to an accessory for a drill press, band saw, jig saw and other similar tools having a stationary working piece, such as a blade or bit. The accessory is a dust and debris collection device which works in association with the tool to remove cuttings generated by operation of the tool. The device is primarily comprised of a frame, a clamp, a hose frame and a vacuum piece. The hose frame is further disposed within the frame and receives the second end of the vacuum piece to allow a vacuum hose to attach to the vacuum piece, to create suction or negative pressure to remove sawdust and other debris generated by the drill or other tool. The vacuum piece has a first end and a second end, in which the first end has a generally circular or half-circular cutout that allows a user to position the piece around a drill bit while the drill is in use. The vacuum piece provides an area of negative pressure or concave suction around the bit, and encompasses approximately 335 degrees to provide a greater circumference of suction in order to thoroughly capture the maximum amount of sawdust and other debris produced by the drill press during use. Accordingly, the present disclosure makes specific reference thereto. Nonetheless, it is to be appreciated that aspects of the present invention are also equally applicable to other like applications, devices and methods of manufacture.

### BACKGROUND

Electrically powered drilling devices, such as drill presses, are traditionally used by professionals, tool and die shops, woodworkers, on construction jobsites and by homeowners and hobbyists for various construction, fabrication and other tasks. Particulate residue in the form of sawdust, metal shavings or other material is created when wood, metal or other materials are drilled using a drill press. Over time, this sawdust, debris and residue can build up on the drilling surface of the drill press and can negatively impact and interfere visually and with the operation of the drill press, and the cleanliness of the surrounding area. Therefore, a user must routinely clean the sawdust, debris and other material from the drill press and the surrounding area.

Typically, a vacuum device is used to vacuum or clean sawdust, cuttings or other debris created by a device such as drill press. However, this process is not only time-consuming and inconvenient, but also tends to interrupt the timeline of the underlying project that the user is working on and causes delays. For example, most users will continue to operate a drill press until the project is complete, or until the sawdust visually impairs, cuttings or other debris interferes with the operation of the press, in an effort to avoid having to repeatedly stop the project to sweep away or vacuum up the sawdust or other debris from the working area of the press. Many existing drill presses may have a designated fitting near the drilling surface to attach a vacuum hose, compressed air hose or other vacuum source to collect sawdust or remove it as it is created by the drilling of material to mitigate this issue. However, this requires a user to take an additional step of powering on the vacuum supply or air compressor, which in turn requires the user to either stop the operation of the cutting device to do so, or to take his or her focus off of the drill press while it is still operational, which can be both inefficient and dangerous.

Additionally, a user may elect to simply leave the vacuum or air compressor on throughout the entire drilling process to circumvent the need to power down the drill press or attempt to turn on the vacuum or air source while also operating the press. This process also creates a large amount of unnecessary noise from the vacuum or compressor, which can lead to hearing damage over time, if the press is being used in an enclosed space. In addition, existing vacuum-type devices that can attach to drill presses are bulky, often visually blocking the view of the working area and offer a limited suction coverage area, which makes it difficult to adequately collect all sawdust and other debris and noise pollution will still be present.

Therefore, there exists a long-felt need in the art for an improved dust collection and debris-removal device. There also exists a long-felt need in the art for a drill press dust collection or debris-removal device that collects and removes dust and other debris from a drill press during operation of the press. Further, there exists a long-felt need in the art for a drill press dust collection and debris-removal device that can be easily attached to a drill press. Finally, there exists a long-felt need in the art for a drill press dust collection and debris-removal device that provides improved, adjustable suction coverage, and does not obstruct view of the working area while drilling or otherwise operating the device.

The subject matter disclosed and claimed herein, in one embodiment thereof, comprises a drill press dust collection and debris-removal device. The device has a frame, a clamp, a hose frame and a vacuum piece. The hose frame is further disposed within the frame, and receives the second end of the vacuum piece to allow a vacuum hose to attach to the vacuum piece to create suction to remove sawdust and other debris. The vacuum piece has a first end and a second end. The first end has a generally circular or half-circular concave cutout that allows a user to position the piece around a drill bit while the drill is in use. The vacuum piece provides an angle of suction around the bit at approximately 335 degrees to provide ample suction in order to thoroughly capture the maximum amount of sawdust, debris and other material produced by the operation of the press, while not substantially obstructing the user's vision.

In this manner, the drill press dust collection of the present invention accomplishes all of the forgoing objectives and provides an improved dust collection and debris-removal device for drill presses and other shop equipment, such as band saws, jig saws and the like, which have a relatively positioned or stationary working piece. Further, the device can be easily attached to a drill press or other tool. Finally, the device provides improved, adjustable suction and additional coverage, and does not obstruct view of the working area while drilling using a drill press or other tool.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a drill press or other tool with a stationery or positioned cutting device, with a dust collection or debris-removal device. The device has a frame, a clamp, a hose frame and a vacuum piece. The adjustable frame is preferably generally rectangular, and has a top member, a generally parallel bottom member and two sets of generally parallel side members. A hose frame is further disposed within the frame which receives the second end of the vacuum piece, to allow a vacuum or other hose to attach to the vacuum piece or air compressor. The vacuum or air piece has a first end and a second end, in which the first end has a generally circular or half-circular cutout that allows a user to position the piece around the cutting area of a drill bit or blade while the bit or blade is in use. The concave vacuum piece provides an angle of suction around the bit ranging from 300 to 350 degrees and preferably about 335 degrees to provide adequate suction and air flow in order to thoroughly capture the maximum amount of sawdust and other debris produced by the press or blade. Suction is created through the piece via an attached vacuum and hose in order to suck sawdust or other debris created while drilling or cutting away from the bit or blade while material is being drilled or cut on a drill press or other tool. The removal tool is optimized for sawdust and other cutting particles ranging from about 70 microns to about 2,000 microns, and works for metal, wood, plastic, fiberglass, etc..

One side member of the frame is preferably comprised of at least one clamp. The clamp allows the device to be easily connected to and secured to the column, platform and/or other structure of a drill press or other tool to ensure the device cannot move during use. The top member of the frame also has at least one continuous opening that corresponds to an at least one continuous opening in the top surface of the hose frame. A pin or other retention piece can then be inserted into both openings in order to secure the position of the hose frame on the frame. As a result, the hose frame can be moved about the frame to precisely position the vacuum piece around a drill bit or saw blade at a variety of distances, angles and positions. The top member may also include at least one indicia that may be in the form of a number or degree measurement that represents the position or angle of each opening, which allows a user to easily return the hose frame to a specific position within the frame during use.

Accordingly, the tool press dust collection and debris removal device of the present invention is particularly advantageous, as it can be easily attached or removed from a drill press or other tool. The device also provides improved, adjustable suction or air flow coverage and does not obstruct the view of the working area while drilling or sawing using a press or other tool. In addition, the device is repositionable at a plurality of angles, distances, and positions to ensure adequate suction and sawdust, debris and other cuttings removal.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a drill press dust collection device of the present invention while attached to a drill press in accordance with the disclosed architecture;

FIG. 2 illustrates a perspective view of one potential embodiment of a drill press dust collection device of the present invention in accordance with the disclosed architecture; and

FIG. 3 illustrates an enhanced perspective view of a vacuum piece of one potential embodiment of a drill press dust collection device of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved dust collection and debris-removal device. There also exists a long-felt need in the art for a drill press or other stationary tool dust collection or debris-removal device that collects dust from a drill or other stationary tool during operation of the drill press or other tool, and for a device that can be easily attached to a drill press or tool. Finally, there exists a long-felt need in the art for a drill press or other stationary dust collection or debris-removal device that provides improved, adjustable suction coverage and air flow, and does not obstruct the view of the working area while drilling.

The present invention, in one exemplary embodiment, is comprised of a drill press or other stationary tool dust collection device having a frame, a clamp, a hose frame and a vacuum piece. The frame further includes a top member, a generally parallel bottom member and two sets of generally parallel side members. A hose frame is further housed within the frame and receives the second end of the vacuum piece to allow a vacuum or other hose to attach to the vacuum piece or compressor to provide a concave suction force or air flow. The vacuum piece has a first end and a second end, and the first end has a generally circular or half-circular cutout that allows a user to position the piece around a drill bit, sanding belt or cutting blade while the bit, blade or band is in use. The vacuum piece provides an angle of suction around the bit, blade or belt ranging from about 300 to 350 degrees and preferably at approximately 335 degrees to provide adequate suction or air flow in order to thoroughly capture the maximum amount of sawdust, debris or other material produced by the press or tool.

One side member of the frame includes at least one clamp that allows the device to be easily attached and secured to the column, platform, and/or other structure of a drill press or other stationary tool. The top member of the frame also has at least one continuous opening that corresponds to an at least one continuous opening in the top surface of the hose frame. A pin or retention bolt can then be inserted into both openings in order to secure the position of the hose frame within or on the frame. As a result, the hose frame can be moved on the frame to precisely position the vacuum or air piece around a drill bit, blade or belt at a variety of distances, angles, and positions. The top member may also have at least one indicia that may be in the form of a number or degree measurement that represents the position or angle of each opening, which allows a user to easily return the hose frame to a specific position within or on the frame during use.

As a result, the drill press or other stationary tool dust collection device of the present invention is particularly advantageous, as it can be easily attached ore removed from a drill press or other tool. The device also provides improved, adjustable, suction coverage, air flow and does not obstruct view of the working area while drilling, cutting or sanding using a drill press or other tool. In addition, the device is repositionable at a plurality of angles, distances and positions to ensure adequate suction and sawdust/debris removal.

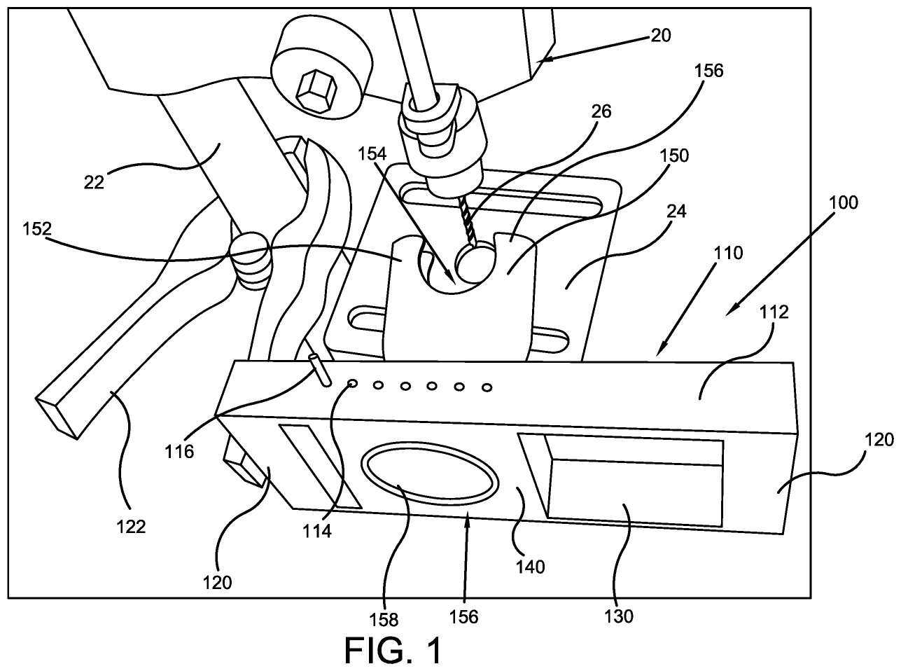

Referring initially to the drawings, FIG. 1 illustrates a perspective view of one potential embodiment of a drill press or other stationary tool dust collection and debris-removal device 100 of the present invention while attached to a stationary tool such as a drill press 20, in accordance with the disclosed structure. The device 100 is primarily comprised of a frame 110, a clamp 122, a hose frame 140 and a vacuum piece 150. It is contemplated that any embodiment of the device 100 may be comprised of any combination of wood, a durable metal such as stainless steel or aluminum, or a plastic such as but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, PVC, etc., unless otherwise specified herein.

The frame 110 is preferably generally rectangular or square and is comprised of a top member 112 and a generally parallel bottom member 130 and two sets of generally parallel side members 120. The top and bottom members are longer than the side member forming a generally rectangular frame. A hose frame 140 is further disposed within a portion of the frame 110. The hose frame 140 receives the second end 156 of the vacuum piece 150 to allow a vacuum hose 12 to attach to the vacuum piece 150. One side member 120 of the frame 110 has at least one clamp 122. The clamp 122 may be fixedly or removably-attached to the side member 120, and in differing embodiments may be any clamp known in the art such as but not limited to: a G clamp, a C clamp, a hand screw clamp, a sash clamp, a pipe clamp, a spring clamp, a bench clamp, a quick action clamp, a trigger clamp, a drill press clamp, a screw clamp, a speed clamp, a sliding clamp, etc. The clamp 122 further allows the device 100 to be easily attached and secured to the column 22, platform 24, and/or other structure of a stationary tool or press 20. In this manner, the device 100 is held in position during use ensuring that the sawdust, debris or other material is removed the area of the cutting, drilling or sanding.

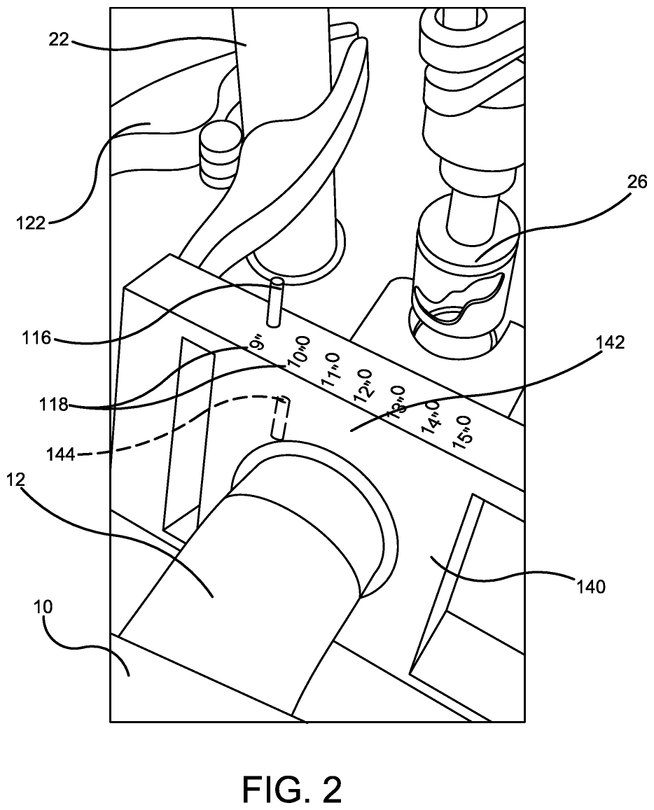

FIG. 2 illustrates a perspective view of one potential embodiment of a drill press or other stationary tool dust collection device 100 of the present invention in accordance with the disclosed structure. The top member 112 of the frame 110 has at least one continuous opening 114. The at least one continuous opening 114 corresponds (e.g., aligns with) to an at least one continuous opening 144 in the top surface 142 of the frame 140. A locking piece such as a pin or plug 116 can then be inserted into both openings 114, 144 in order to secure the position of the hose frame 140 within the frame 110. In this manner, the hose frame 140 is slidable and can be moved within the frame 110 to precisely position the vacuum piece 150 around a cutting element such as a drill bit 26 of a drill press or tool 20, at a variety of desired distances, angles, and positions. In differing embodiments, the top member 112 further includes at least one indicia 118 that may be in the form of a number or degree measurements that represents the position or angle of each opening 114. In this manner, the indicia 118 easily allows a user to return the hose frame 140 to a specific position within the frame 110 during use.

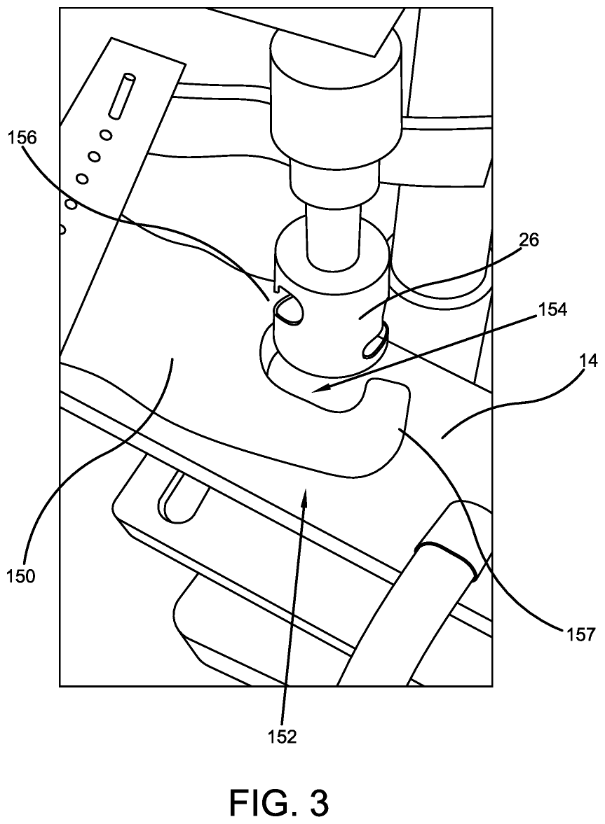

FIG. 3 illustrates an enhanced perspective view of a vacuum piece 150 of one potential embodiment of a tool dust collection or other debris-removal device 100 of the present invention in accordance with the disclosed specification. The vacuum piece 150 is comprised of a first end 152 and a second end 156. The vacuum piece 150 may also be provided with one or more extension pieces 157 that can be added to either the first or second ends 152 and 156 or both ends, creating an additional coverage area around the cutting element. The first end 152 is curvilinear in shape, which includes a generally circular or half-circular cutout 154, which in differing embodiments may also be any other general shape known in the art such as but not limited to: triangular, square, rectangular, octagonal, trapezoidal, hexagonal, etc. If one or more extension pieces 157 are provided, the entire area around the cutting element can be surrounded to maximize removal of debris. The cutout 154 allows a user to position the piece 150 around a cutting element 26 as a piece of a material 14 is being cut or drilled on a drill press 20. It should be noted that the shape of the cutout 154 does not obstruct the working area of the bit or cutting element 26, and allows for the angle of suction around the bit 26 to be between 300 and 350 degrees and preferably approximately 335 degrees to provide a superior or advanced suction or air flow in order to thoroughly capture the maximum amount of sawdust, debris or other cuttings produced by the tool 20. The second end 156 has a continuous opening 158 that is sized appropriately to receive the hose 12 of a vacuum 10. In this manner, the vacuum 10 can be powered on to create suction and sufficient air flow through the piece 150 in order to withdraw sawdust, cuttings or other debris created while drilling, cutting or sanding, away from the work platform 24, the cutting element 26, and the material 14 being worked on. The removal tool is optimized for sawdust and other cutting particles ranging from about 70 microns to about 2,000 microns.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “drill press or tool dust collection or debris-removal device” and “device” are interchangeable and refer to the drill press or tool dust collection device 100 of the present invention.

Notwithstanding the forgoing, the drill press or tool dust collection or debris-removal device 100 of the present invention and its various components can be of any suitable size and configuration as is known in the art, without affecting the overall concept of the invention, provided that they accomplish the above-stated objectives. One of ordinary skill in the art will appreciate that the size, configuration and material of the drill press or stationary tool dust collection or debris-removal device100 as shown in the FIGS. are for illustrative purposes only, and that many other sizes and shapes of the drill press dust collection device 100 are well within the scope of the present disclosure. Although the dimensions of the drill press dust collection device 100 are important design parameters for user convenience, the drill press dust collection device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An accessory for a stationary tool, the accessory comprising:
a frame having a top and a bottom and two side edges, wherein the frame is mounted to a support of a stationary tool;
a hose frame sized and configured to fit within the frame, the hose frame movable within the frame; and
a locking piece positioned on the frame for locking the hose frame in a position on the support of the stationary tool.

2. The accessory as recited in claim 1, wherein a first end of a hose is connected to the hose frame on a first side of the hose frame and a second end of a hose is connected to an air flow device.

3. The accessory as recited in claim 2, wherein the air flow device is one of an air compressor or vacuum and the air flow device is for removing sawdust, debris or other material from a cutting area.

4. The accessory as recited in claim 3, wherein the sawdust, debris or other material has a particle size ranging from 70 microns to 2,000 microns.

5. The accessory as recited in claim 2, wherein the first end of the hose is connected to a vacuum piece and the vacuum piece extends at least partly around a cutting area of a stationary tool.

6. The accessory as recited in claim 5, wherein the vacuum piece is comprised of two ends which form a generally circular or curvilinear opening around the cutting area.

7. The accessory as recited in claim 6, wherein the vacuum piece further comprises an extension connectable to at least one of the two ends for enclosing the cutting area.

8. The accessory as recited in claim 2, wherein the first end of the hose is connected to the frame by a clamp.

9. The accessory as recited in claim 1, wherein the locking piece is one of a pin or retention plug.

10. The accessory as recited in claim 1, wherein the stationary tool includes one of a drill press, band saw, jig saw or belt sander.

11. A stationary tool and debris removal combination comprising:
a stationary tool having a supporting frame, a cutting area and a working tool;
a frame for connecting a debris removal device to the supporting frame, the frame having top and bottom edges and side walls, wherein the top and bottom edges are longer than the side walls forming a rectangular frame;
the frame is connected to a side of the supporting frame; and
a hose connection frame disposed within the frame, wherein the hose connection frame is moveable within the frame.

12. The stationary tool and debris removal combination as recited in claim 11 further comprising an air flow hose connected to a first side of the hose connection frame and held to the hose connection frame by a clamp.

13. The stationary tool and debris removal combination as recited in claim 12, wherein the air flow hose has a vacuum piece attached to a first end of the air flow hose.

14. The stationary tool and debris removal combination as recited in claim 13, wherein the vacuum piece has a central portion and two ends extending away from the central portion.

15. The stationary tool and debris removal combination as recited in claim 14, wherein the two ends form a generally circular opening which extends around the cutting area.

16. The stationary tool and debris removal combination as recited in claim 15, wherein an extension piece may be added to one or both ends of the vacuum piece to further enclose the cutting area.

17. The stationary tool and debris removal combination as recited in claim 13, wherein the vacuum piece can be adjusted around the cutting area at an angle ranging from 300 to 350 degrees.

18. The stationary tool and debris removal combination as recited in claim 17, wherein the vacuum piece can be adjusted around the cutting area at an angle of about 335 degrees.

19. A sawdust removal device for a drill press, the sawdust removal device comprising:
a frame having a top end and a bottom end and two side members, the top, bottom and side members forming a rectangular frame;
a hose connection frame sized and configured to fit within the frame, the hose connection frame movable within the frame;
a locking element disposed on the frame to hold the hose connection frame within a predetermined position within the frame;
a vacuum hose connected to one side of the hose connection frame; and
a vacuum piece connected to the vacuum hose and extending around at least a portion of a cutting area and the vacuum piece adjustable between an angle ranging from 300 to 350 degrees.

20. The sawdust removal device as recited in claim 19, wherein the locking element includes one of a pin or retention plug and the vacuum piece forms a generally curvilinear opening around the cutting area.
